(19) United States
(12) Patent Application Publication
(10) Pub. No.: US 2016/0063209 A1
(43) Pub. Date: Mar. 3, 2016

(54) SYSTEM AND METHOD FOR HEALTH CARE DATA INTEGRATION

(71) Applicant: RADICALOGIC TECHNOLOGIES, INC. DBA RL SOLUTIONS, Toronto (CA)

(72) Inventor: Sanjay Malaviya, Mississauga (CA)

(21) Appl. No.: 14/839,126

(22) Filed: Aug. 28, 2015

Related U.S. Application Data
(60) Provisional application No. 62/043,066, filed on Aug. 28, 2014.

(51) Int. Cl. G06F 19/00; G06N 5/04; G06N 99/00

(52) U.S. Cl. CPC G06F 19/3431; G06N 99/005; G06N 5/046; G06F 19/3437

(57) ABSTRACT

Systems and methods for integrating data from various sources are provided, the system comprising a processor and a non-transitory computer readable storage medium storing instructions which when executed by the processor, configure the processor to filter and transform data received from one or more health care organizations by: receiving one or more data sets; developing one or more rules based upon the one or more data sets; and applying the one or more rules to the one or more data sets to detect the presence of one or more data elements.

### CROSS REFERENCE TO RELATED APPLICATION

This application claims priority to U.S. Provisional Application No. 62/043,066 filed Aug. 28, 2014, the entire contents of which is hereby incorporated by reference.

### FIELD

The embodiments described herein relate generally to health care systems and data interfaces.

### INTRODUCTION

The management of health care data may be of importance for both acute and long-term health care. The ability to analyze and develop relationships and correlations based upon health care data provides opportunities, for example, to create treatment regimens, to more closely monitor existing conditions, to manage health care liability, to determine root causes of incidents, to conduct analyses across demographics, geographies, and/or to better monitor and prevent the spread of infectious diseases. In the health care sector, these data-driven opportunities may lead to improved patient safety and health outcomes. However, an ongoing challenge the health care industry faces may be interoperability between different data sources.

### SUMMARY

In an aspect, there is provided an interface automation system comprising: a training unit for processing labeled training data using machine learning operations for rule generation to generate a training rule set for mapping feature data to one or more target variables; a data interface for receiving input data from data sources of two or more information systems, an interface type, and a selected one or more target applications; a preprocessor for validating and tagging the input data, the tagging identifying data element locations within the input data; and an integration framework unit for dynamically updating interface rules to expand the training rule set using the machine learning operations and the tagged input data, the integration framework unit generating deployable configuration files for an interface for transforming and integrating input data based on the one or more data sources and the one or more target applications, the interface being of the interface type, the deployable configuration files configuring the interface on an interface appliance connecting the two or more information systems and the one or more target applications.

In some embodiments, the labeled training data comprises class-labeled training tuples of types x and Y, where x is a vector of input variables (x1, x2, x3, . . . , xn) and Y is the one or more target variables that the training unit is attempts to understand using the machine learning operations for the rule generation.

In some embodiments, the configuration files comprise parameters or rules to control the transformation and integration of the input data, each parameter or rule associated with a confidence score, the confidence score being a variable value to estimate the accuracy and utility of the parameter or rule, the confidence score being within a predetermined threshold.

In some embodiments, a client application for providing a visual representation of the configuration files, receiving feedback regarding accuracy of the configuration files, refining the machine learning operations based on the received feedback, and updating the configuration files using the refined machine learning operations.

In some embodiments, a rules engine manages the interface rules based on the expanded training rule set, each interface rule for configuring one or more parameter of the configuration files for the transforming or integrating of the input data to one or more target variables, each interface rule defined by a path traversing a series of decisions nodes in a tree data structure to map observations from the input data to conclusions about the input data, wherein the path configures the one or more parameters of the configuration files.

In some embodiments, the interface appliance is connected to the integration framework unit to dynamically receive new and updated configuration files.

In some embodiments, the interface appliance forms part of the interface automation system to dynamically receive new and updated configuration files.

In some embodiments, the input data comprises a set of features defined by one or more attributes of one or more data elements, wherein the rules engine of the interface rules uses the machine learning operations to discover, identify and classify the set of features of the input data to update or refine the interface rules.

In another aspect, embodiments described herein provide an interface appliance comprising: at least one input port connecting to two or more information systems to receive input data from data sources of the two or more information systems; a data interface for receiving an interface type, and at least one selected target application; at least one output port connecting to at least one target application for providing output data generating by transforming and integrating the input data; at least one deployable configuration file for generating an interface on the interface appliance connecting the two or more information systems and the at least one selected target application, the interface being of the interface type; a preprocessor for validating and tagging the input data, the tagging identifying data element locations within the input data; and an integration framework unit for dynamically updating interface rules using the machine learning operations and the tagged input data, the integration framework unit generating the deployable configuration files for the transforming and integrating of the input data based on the one or more data sources and the one or more target applications.

In some embodiments, the configuration files comprise parameters or rules to control the transformation and integration of the input data, each parameter or rule associated with a confidence score, the confidence score being a variable value to estimate the accuracy and utility of the parameter or rule, the confidence score being within a predetermined threshold.

In some embodiments, a client application provides a visual representation of the configuration files, receiving feedback regarding accuracy of the configuration files, refining the machine learning operations based on the received feedback, and updating the configuration files using the refined machine learning operations.

In some embodiments, the integration framework unit connects with a rules engine to manage the interface rules, each interface rule for configuring one or more parameter of the configuration files for the transforming or integrating of the input data to one or more target variables, each interface rule defined by a path traversing a series of decisions nodes in a tree data structure to map observations from the input data to conclusions about the input data, wherein the path configures the one or more parameters of the configuration files.

In some embodiments, the integration framework unit dynamically updates the configuration files on the interface appliance based on refinement of the machine learning operations.

In some embodiments, the input data comprises a set of features defined by one or more attributes of one or more data elements, wherein the rules engine of the interface rules uses the machine learning operations to discover, identify and classify the set of features of the input data to update or refine the interface rules.

In some embodiments, the input data comprises unstructured textual data.

In some embodiments, the input data comprises metadata about data values, and wherein the tagging identifies the metadata as tags.

In some embodiments, the input data comprise one or more near-real time or real time data feeds regarding machines, devices and patients of the one or more health care organizations and other data relevant to the one or more health care organizations for incident prediction.

In some embodiments, the input data comprise batch data feeds regarding machines, devices and patients of the one or more health care organizations and other data relevant to the one or more health care organizations for incident prediction.

In some embodiments, the integration framework unit determines a confidence interval for the configuration files and compares the confidence interval to a threshold to trigger a flag.

In another aspect, there is provided a method for interface automation comprising: receive input data from a plurality of client or healthcare information system interfaces; reprocess the source data to identify and filter invalid data; tag attributes and data elements of the input data with tags; receive a selected target application and interface type; process the input data using the tags, a rule-specific tree data structures, and machine learning operations to generate configuration files; and transmit the configuration files to an interface appliance connecting to the plurality of client or healthcare information system interfaces and the target application.

In some embodiments, the method further comprises providing a visual representation of the configuration files; receiving data quality confirmation about the configuration files based on the visual representation; updating the learning operations based on the data quality confirmation; and generating deployable configuration files.

### BRIEF DESCRIPTION OF THE DRAWINGS

In the drawings, embodiments of the invention are illustrated by way of example. It is to be expressly understood that the description and drawings are only for the purpose of illustration and as an aid to understanding, and are not intended as a definition of the limits of the invention.

FIG. 1 is a diagram of the interface automation system, which includes the majority of the components that implement the invention, according to some embodiments.

FIG. 2 is a diagram of the relevant components within a physical appliance, according to some embodiments.

FIG. 3 is a flow chart of a method for interface automation, according to some embodiments.

FIG. 4 is a computing device, which may be utilized in the implementation of some embodiments.

FIG. 5 is a flow diagram of part of a decision tree, which is as an example of a rule mapping, according to some embodiments.

FIG. 6 is a schematic diagram of a system for health care data integration using an interface appliance and configuration files according to some embodiments.

### DETAILED DESCRIPTION

The embodiments described herein relate to health care system interoperability. The embodiments described herein relate to systems for generation and implementation of data interfaces, where the interfaces may be used to integrate different data sources, including similar and disparate sources, and transform and translate data between different systems (client and backend server, for example).

The embodiments described herein relate to an interface appliance configured to integrate and map client data sources to backend server data formats. The interface appliance has the ability to analyze and develop relationships and correlations for health care data to, for example, create treatment regimens, monitor existing conditions, manage health care liability, determine root causes of incidents, conduct analyses across demographics and geographies, and/or to better monitor and prevent the spread of infectious diseases. This may lead to improved patient safety and health outcomes.

The interface appliance may provide interoperability between disparate data sources from hospital information systems using various data models based on different health data standards, customizations with variance and so on.

Hospital information systems (HIS) are integrated systems that help with the administration and coordination of patient care and financial management. For general acute care hospitals, each department may have its own information system. For example, the laboratory department may have a lab information system (LIS) and the radiology department may have a radiology information system (RIS). There are different systems for different aspects of service. In large health systems (i.e. multi-hospital systems), the relationships between hospitals, departments, and information systems can be complex. Data entered into or otherwise captured by these systems may be transported to ancillary systems through real-time or batch interfaces depending on requirements and available functionality. Health data interfaces may enable communications of events and data between the HIS and any ancillary systems or applications that need to be aware of, for example, patient events that occur during a given episode of care. Other example systems include inventory systems, maintenance systems, scheduling and staffing systems, and so on.

While the need for real-time and near-real-time information exchange continues to grow, health care providers are hampered with home-grown and legacy systems and applications that do not connect or interface the disparate data systems and sources. These hospital information systems drive administrative, clinical and financial results for the healthcare provider, and their ability to exchange timely and reliable information of high data quality may be impactful to many initiatives and policies.

While standards for the sharing of health care data continue to evolve, semantic interoperability may be a challenge at the industry level. Health Level 7 (HL7) version 2 (v2) is a widely adopted international standard for sharing information between medical applications. This standard does not have an explicit data model, which may be a trade-off for site-specific flexibility. There may be variances from provider to provider as reflected in the design of the standard. The standard accommodates these variances through its flexibility, but at a cost. The cost may be apparent when modern systems need to acquire and aggregate data across providers (e.g. population health or industry benchmarking). Likewise, when implementing a solution across multiple providers and attempting to re-use interface code, these variances are adversely impactful to implementation projects, even when working with the same interface types from the same information system vendor/version.

Newer standards that are part of HL7 v3 family of specifications, such as CDA/CCD, HQMF and others, may employ complex reference information models, potentially making implementation time consuming and resource intensive. Further, health data may be coded for medical classification or facility-specific meaning, which may complicate the extraction, filtering and mapping processes involved in generating interfaces to integrate the health data with a given target application.

As a result, there may be data variance across different data systems and sources for the same health care providers and different health care providers, even when the same hospital information systems and interface types are compared. Accordingly, data interface implementation may be a complex and time-intensive process, and may also require specialized knowledge of various health data standards and formats, as well as knowledge of how the data may be used by target applications.

These challenges may increase the effort required to acquire and integrate health data and may further lead to inefficiencies and errors in data storage, consolidation and comparison, potentially impacting the ability of a health care organization to improve health outcomes for their patients.

Embodiments described herein may provide an interface appliance or an interface automation system. Components interoperate as a system for the intake and integration of health data and its automated processing and output. The files and information that comprise the output may be used to build a specialized data interface appliance through an iterative and interactive machine learning process. The process may be automated or semi-automated and may allow for confirmation or feedback of output that has been measured for reliability. Changes and confirmations may be fed back into the system to drive supervised machine learning over time, potentially increasing the breadth of health data the system can accommodate, as well as the quality and veracity of its output.

An interface appliance may be provided to aid interoperability between two or more systems or data sources, which may utilize the same or different health data standards for sharing health data. Even when systems may utilize the same standard, the systems may utilize the standards differently. Some standards provide flexible schemas that may be adapted and customized for various uses, or the standards may be utilized inconsistently or incorrectly.

In some embodiments, a data interface appliance may be implemented using configuration files and then may be installed at a client site for operation and connection to different backend servers and applications.

Embodiments described herein may provide a system for an integration framework and rules engine, where integration may refer to the acquisition, filtering, transformation and delivery of near-real, real-time and batch data from one or more hospital information systems to one or more destinations. The rules engine may configure rules and instructions to define a set of procedural and logical information that control how data provided by the integration framework may be used to enable various features and functionality within a given target application.

The integration framework and rules engine may operate in concert for service of a given target application.

In some embodiments, the system or appliance may have a processor and a non-transitory computer readable storage medium storing instructions which when executed by the processor, configure the processor to integrate data received from one or more health care organizations. The processor may implement one or more example operations such as: receiving one or more data sets; processing and training on known data sets; applying facility- and/or interface type specific logic to prepare the one or more data sets for subsequent processing; pattern detection across disparate data sets using a rules engine and machine learning to generate interface mappings and libraries; or running the prepared data through one or more rules or instructions that are specific to a given target application.

In some embodiments, a physical interface appliance—a hardware device—may be provided to connect to one or more HIS or other data sources located at a particular facility. The one or more HIS may provide the interface appliance with near-real, real-time and batch data containing information relevant to the management of health care for patient populations associated with one or more facilities.

In this embodiment, the physical appliance may have one or more processors and one or more non-transitory, computer readable media, wherein the processors are configured to run a set of applications that work in concert to serve as an integration framework and rules engine to generate, control and manage the data interfaces.

In some embodiments, a pair of fault-tolerant interface appliances may operate as a two or more multi-node cluster in order to ensure high availability for applications and client data that may reside on these physical devices.

In some embodiments, the integration framework and rules engine are a set of applications that may be executed on one or more computers, or implemented using a cloud-computing-type distributed computing network.

Embodiments of the invention are not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of illustrative description and other equivalents may be used.

Features of the systems, devices, and methods described herein may be used in various combinations, and may also be used for the system and non-transitory computer-readable storage medium in various combinations.

The embodiments of the systems and methods described herein may be implemented in hardware or software, or a combination of both. These embodiments may be implemented in computer programs executing on programmable computers, each computer including at least one processor, a data storage device (including data storage elements), and at least one communication interface. For example, and without limitation, the various programmable computers may be a server, network appliance, embedded device, personal computer, laptop, or any other computing device capable of being specifically configured to carry out the methods described herein.

Program code may be applied to input data to perform the functions described herein and to generate output information. The output information may be applied to modify or control one or more output devices. In some embodiments, the appliance interface may be a network communication interface. In embodiments in which elements of the invention are combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or a combination thereof, to communicate with a computer system. However, alternatively the programs may be implemented in assembly or machine language, if desired. The language may be a compiled or interpreted language. A computer program may be stored on a storage media or a device (e.g., ROM, magnetic disk, optical disc), readable by a general or special purpose programmable computer, for configuring and operating the computer when the storage media or device may be read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments may be capable of being distributed in a computer program product including a physical, non-transitory computer readable medium that bears computer usable instructions for one or more processors. The computer useable instructions may also be in various forms, including compiled and non-compiled code.

Throughout the following discussion, numerous references will be made regarding servers, services, interfaces, platforms, or other systems formed from computing devices. It should be appreciated that the use of such terms may be deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. One should appreciate that the systems and methods described herein may transform electronic signals of various data objects into three dimensional representations for display on a tangible screen configured for three dimensional displays. One should appreciate that the systems and methods described herein involve interconnected networks of hardware devices configured to receive data using receivers, transmit data using transmitters, and transform electronic data signals for various three dimensional enhancements using particularly configured processors, where the three dimensional enhancements are for subsequent display on three dimensional adapted display screens.

The following discussion provides many example embodiments of the inventive subject matter. Although each embodiment represents a single combination of inventive elements, the inventive subject matter may be considered to include all possible combinations of the disclosed elements. Thus if one embodiment comprises elements A, B, and C, and a second embodiment comprises elements B and D, then the inventive subject matter may be also considered to include other remaining combinations of A, B, C, or D, even if not explicitly disclosed.

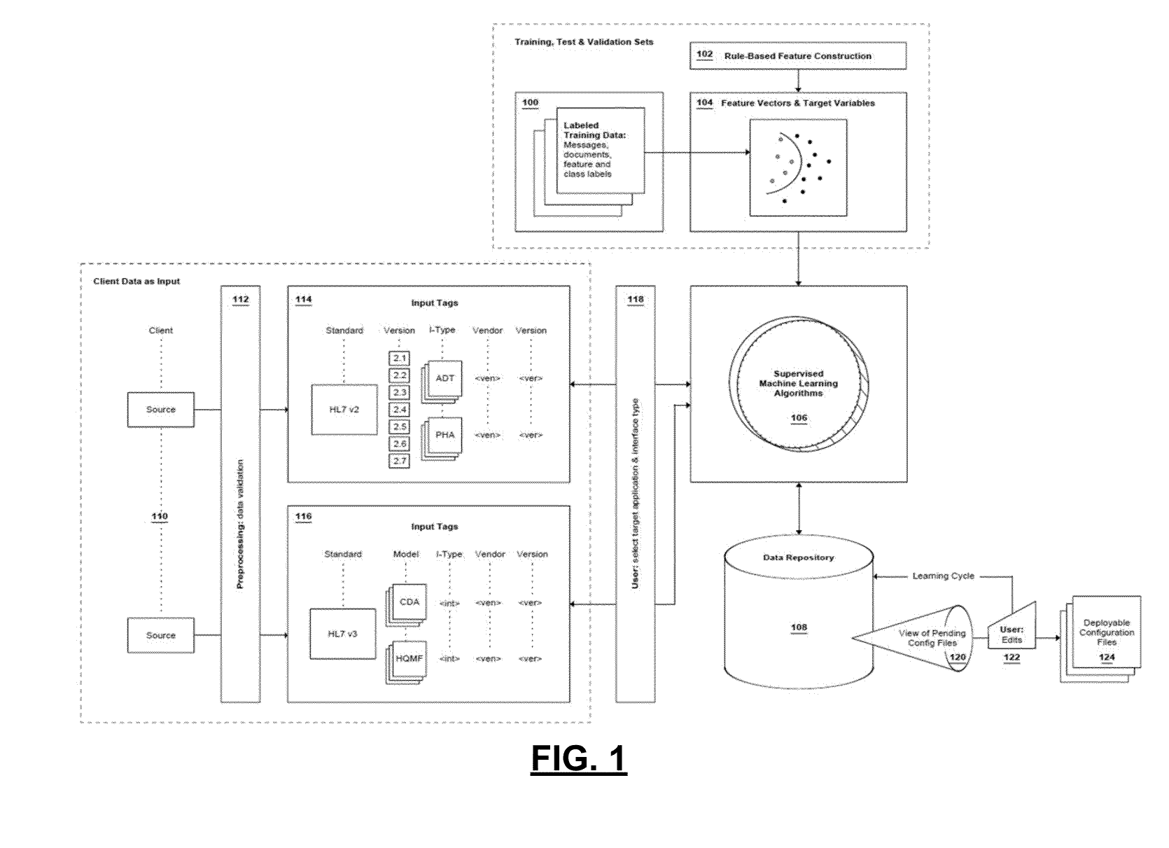

FIG. 1 shows an example interface automation system architecture according to some embodiments. There may be various ways of training the system with regards to developing linkages, mappings and libraries between various types of data sources and target applications, inputs and various interface rules, this is an illustrative example of some embodiments of the invention.

The interface automation system may be configured for operation in relation to physical systems, such as large scale healthcare systems having data stores that span multiple facilities and physical devices, and communicate large amounts of healthcare related data. For example, such systems may include systems for hospitals, clinicians, hospital groups, pharmaceutical companies, laboratories, pharmacies, inventory, maintenance, staffing, and so on.

The interface automation system may be configured for the development of interfaces that enable interoperability and/or integration between two or more systems, which may utilize the same or different standards for sharing health data. Even where the systems may utilize the same standard, the systems may utilize the standards differently. Some standards provide flexible schemas that may be adapted for various uses, or the standards may be utilized inconsistently or incorrectly.

Improving and/or automating interfaces for interoperability may have impacts on the accuracy of healthcare information, reducing labor from administrators, refine learning rules over time, and so on. Accordingly, the system may provide cost savings opportunities and may be commercially advantageous.

The system may generate and/or configure health data interfaces that may connect a given hospital information system with a given target application. The target application may have a defined data taxonomy or model. The interface appliance may transform the source data into output data structures based on the data taxonomy or model, There can be a many-to-many relationship between HIS (and other data sources) and target applications. For example, multiple HIS may be integrated with one target application. In an example, three discrete health data interfaces may need to be implemented, where each may be configured to support its relevant HIS. In some examples, a specific interface appliance may be configured to handle multiple HIS data sources. The target application may make use of patient-level information from all three HIS to enable various features and functionality. Further, a single HIS may be integrated with multiple target applications. For example, the hospital's patient administration system may provide patient demographics and location information to two discrete target applications: one for infection control and one for reporting adverse events.

The configuration files that may be generated from the interface automation system may be used to implement and generate a given health data interface appliance. Each configuration file may be comprised of parameters that control the behavior of the interface application, and these parameters comprise a given set of rules (or “rule set”) that may be required by the target application. The parameters and set of rules may control transformation of input date from different data sources into output data compatible with the target applications and ingestible into data models of back-end server(s). There may be different configuration files for different target applications. A given interface appliance may be generated using different sets of configurations files to provide a flexible tool that can map input data from different data sources to different target applications. The configurations files may be updated so that the interface appliance is in turn updated to dynamically and flexible implement data transformations and integrations. The interface appliance may be connected to the interface automation system to receive new and updated configuration files.

The interface automation system may apply machine learning techniques to aid in the interface configuration file building process. For example, the system may implement a training stage based on one or more known structures for a data source to generate an initial rule set. In some examples, the system may employ supervised learning with decision tree-based methods to generate rule sets and expand on the initial rule set. More specifically, in some examples, the system may implement a classification and regression tree (CART) analysis of the input data to automatically learn how to configure the rule set for a given interface in support of a given target application. Implementations using other types of techniques may also be possible.

Decision trees may be a non-parametric supervised learning method used for classification and regression. The model predicts pathways through a given decision tree based on labeled training data. In this model, each rule may traverse a series of decisions—in some embodiments, binary splits in its tree structure—to map observations from the input data to conclusions about that data, which configure the rule or mapping for the data transformation. Further, because each rule may require its own tree, for more complex rules which may involve patient-centric data groupings, the system may implement gradient tree boosting or random forest classifiers to construct and traverse multiple trees. In some embodiments, splits in the trees may have one or more potential paths which may generate complex or embedded rules for the interface.

The system may receive signals for selection of the one or more target applications and its interface type prior to executing the initial run of the system rule generation stage. An operator may also review system output, entering new information (e.g. to fill in gaps) and corrected information (e.g. to override system efforts), which will be recorded by the system to enhance future efficiency of the relevant algorithms. Because human feedback or confirmation or error detection may be returned to the system, the learning may be interactive.

Once implemented, the interfaces may enable the sharing of electronic health data from one or more hospital information systems with one or more target applications.

The interfaces may be controlled by the configuration files according to the type of data they receive as input and provide as output, and the target application they support. In some embodiments, the interfaces may be defined through one or more parameters or instructions that may be saved in one or more configuration files. Parameters may be understood as rules that define how health care related data (e.g. patient, maintenance, inventor, staffing, cleaning, billing), or other information relevant to the health care organization may be used to enable features and functionality within a given target application. The configuration files may define mappings and libraries to generate a specialized interface appliance to transform input data from data sources into output data suitable for target applications. The parameters may be associated with a confidence score that may be compared to one or more threshold values before becoming part of a configuration file to ensure an appropriate level of accuracy or confidence in the learned parameter. User feedback may further increase accuracy or may be required if a confidence score falls outside of the one or more threshold values.

These configuration files and their associated parameters may be updated overtime by the interface automation system and refined as the system applies various learning and/or feedback techniques to improve the mapping in the configuration files. The configuration files may be dynamically updated and continuously refine the interface appliance using learning techniques and feedback. The rules may be used to generate configuration files for the data transformations, in some examples. The interface appliance may connect to the interface automation system to receive updated and new configuration files over time.

The system may implement a training stage to generate an initial rule set for interface generation. The training data 100 may be comprised of various types of health data, including HL7 v2 messages and extensible markup language (XML) documents that are based on one or more reference information models defined in the HL7 v3 family of standards. There may be known patterns and formats for the training data in some examples. These data may be standards-based in their format and structure and carry salient health information at the patient level. Training data may also be comprised of messages and documents that carry insurance, billing or other business information at the institutional, facility or patient level, such as electronic data interchange (EDI) messages. There may be other example data sets relevant to the health care organization, such as doctor and staff reports, and so on. These data may first be divided into their standard-specific groupings, and then each standard-group may be further divided into non-overlapping data sets used to train, validate and test the supervised learning algorithms 106 to generate an initial rule set that may expand overtime. The predictive model may be built using cross-validated training data, where the training set may be further divided into training and test sets in order to measure the error rate and/or avoid overfitting.

In general, for each standard-group, training data 100 may be comprised of class-labeled training tuples of types x and Y, where x may be a vector of input variables (x₁, x₂, x₃, . . . , xₙ) and Y may be the dependent (target) variable that the process may be attempting to understand for rule generation. The vector x may be described as a feature vector 104, in that each variable may be a feature, or decision point, along the path to Y. Thus, each algorithm may be trained with a set of features that predict the pathway through one or more decision trees to a successful configuration of a given rule the system may be attempting to automate.

The scatter plot data structure 104 defines a non-linear decision surface that the learning trees may need to accommodate to generate rules.

To provide a more fulsome description of features within a given vector, take the example of an HL7 v2 data set, where admission, discharge, transfer (ADT) may be the type of interface being automated. An ADT system may be understood as one type of HIS, which may be used for patient administration. An ADT interface therefore transmits and transforms patient data from different data sources for a hospital to a given target application, such as risk management application, for example. The first interface rule may simply need to determine whether or not a given data element may be available in the ADT data at hospital. A common data element, such as the patient's Discharge Date may be normally carried in the patient visit segment of the HL7 message, specifically in PV1.45. The presence or non-presence of this data element in the ADT data may be a binary decision resolved by traversing paths of a classification tree that, through training, may be constructed for this specific interface rule. Further, each decision point along the path may be a binary split, where the system may be checking for a date field in a series of standards-defined, prioritized locations within a message or a set of messages.

Thus in the context of HL7 v2 patient data, some features may be understood as a series of tests on one or more attributes of one or more data elements. The attribute being tested for the data element Discharge Date in this simplified example is presence: is it available or not? There may however be a significant number of attributes that may be tested as the algorithm's predictive function traverses a given decision tree. Accordingly, input data from different data sources may include a set of features defined by one or more attributes of one or more data elements. The interface rules are updated or refined using machine learning operations to discover, identify and classify the set of features of the input data using decision trees and paths thereof.

Further, attributes of ADT data elements may include as Date of Birth, Marital Status, Ethnicity and various other demographic information, as well as Admit Reason, Patient Identifier, Assigned Patient Location and various other clinical-, identification-, and location-related information. Each attribute may have a corresponding data value within the input data that may be identified and classified using machine learning. These attributes may be combined or compared with other features or attributes to support more complex interface rules. This process may be described as feature construction 102.

Source data 110 may be specific to the client's hospital information system or systems, and is to be integrated with one or more target applications, where the integration may require one or more data transformations or mappings between the input data and target data formats. Source data 110 may be preprocessed 112 for data validation, the purpose of which may be to identify any data that may be invalid (i.e. unable to be processed by subsequent components of the system). Invalid data may be stored in a separate error queue and may be reviewed manually to identify the nature of the issue. In some cases, a small change to the data may be applied to resolve the issue, however in more severe cases; the client hospital may need to be contacted in order to define next steps. The resolution of an error of a specific type may trigger auto-correction of other errors of the same type and provide feedback or input into the machine learning operations.

Valid data may then be tagged (with input tags 114 and 116) with metadata to facilitate subsequent processing by the learning operations 106. The tags 114 and 116 may identify data element locations within the input data. For example, the tagging may identify an attribute (data element) and a location of the attribute within a data structure of the input put. Tagging may aid in the automation of interface rules in cases where a classification or regression tree analysis fails to locate the data element or elements for a given rule due to data variance. The system may overcome variance issues by recording data element locations that may be specific to a particular HIS vendor/version and interface type, and/or making this information available to the learning algorithm in subsequent iterations. The tags 114 and 116 may identify a data standard to provide additional information to the learning operations (e.g. may identify common data elements to look for, formatting of data elements, and so on), versions of the standard, interface type, vendor target data, client target data, version for target data, locations of data elements, attribute type, data value type, and so on.

Once the source data has been received, preprocessed and/or tagged by the system; the source data and any meta data may be made available to a given learning process when requested by the user interface 118. For example, the user may select a target application (e.g. incident reporting) and then an interface type (e.g. ADT), and the learning operations may iterate through a set of incident reporting interface rules (from data repository 108 or training, testing and validation sets) that may be required for ADT by testing attributes within the client-specific data (e.g. data sources 110). The machine learning operations 106 providing an attempt to automate the configuration of this ADT interface by checking a match between incident reporting interface rules and the client-specific data to identify relevant data elements and their corresponding location.

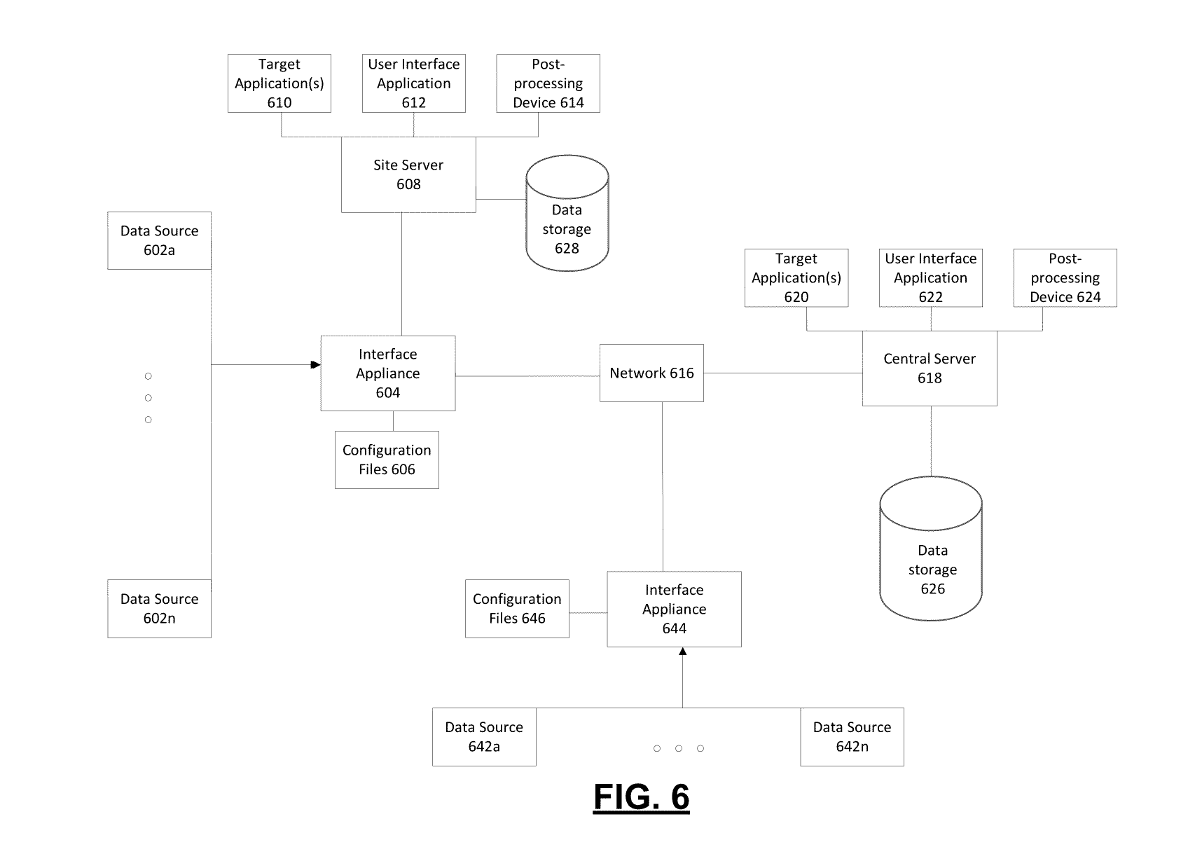

The output of machine learning operations 106 may be stored in a data repository 108. Example output includes pending configuration files 120 or parameters used to generate the pending configuration files 120. A view of pending configuration files 120 may be provided to a user interface 122 for review, feedback and editing. As described, the configuration files 120 contain parameters/rules that the system may have attempted to automatically configure using the interface rules of rules engine and machine learning 106. Further, these parameters/rules may be flagged by the system with information that may allow for understanding of the results of the system's efforts at interface automation. After the user has submitted any edits to the interface rules, these changes or feedback are returned to the system as part of interactive learning and the completed interface configuration files are now ready for deployment. The final output may be deployable configuration files 124 for an interface appliance (e.g. FIG. 6 interface appliance 604). The deployable configuration files 124 may be updated and added to overtime which in turn update the corresponding interface appliance. Accordingly, the interface appliance may be connected to system in order to receive the deployable configuration files 124 and updates thereto.

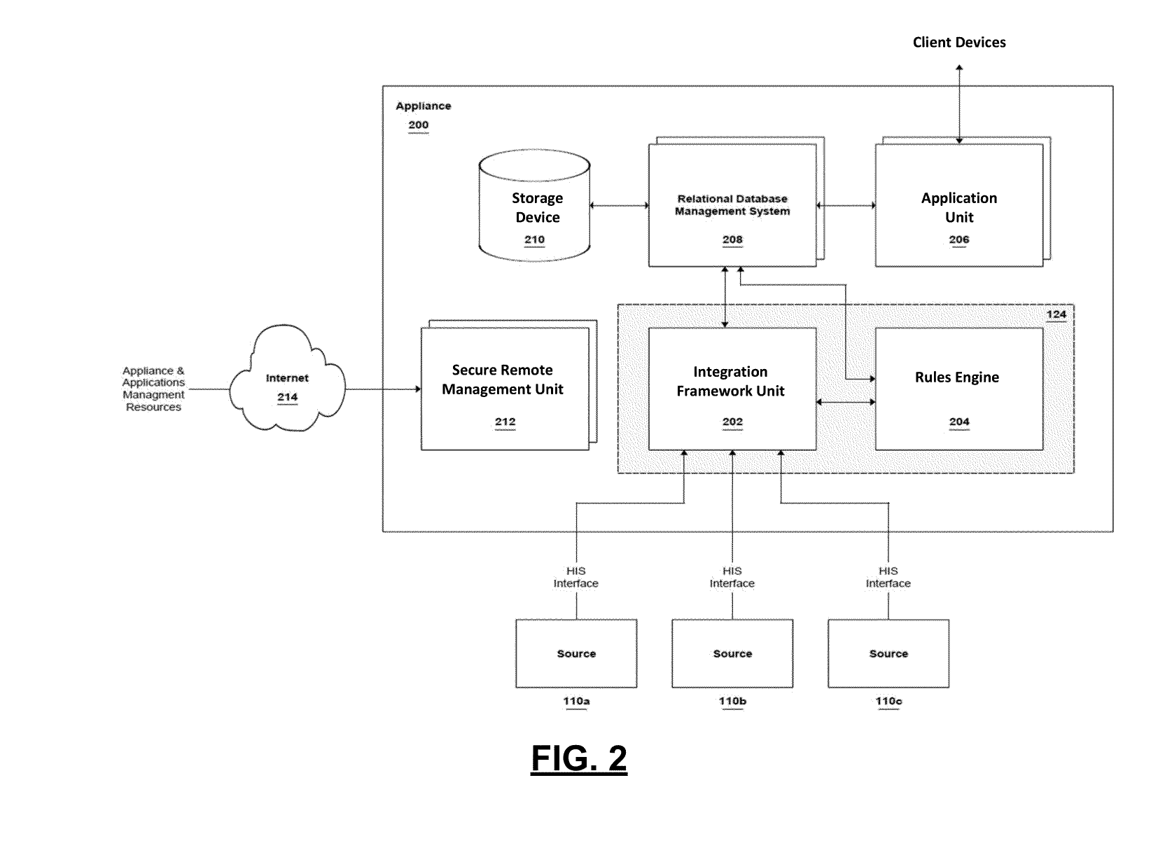

Referring to FIG. 2, a block diagram illustrating the components of an appliance 200 may be provided, according to some aspects of the invention. The appliance 200 may be comprised of an integration framework unit 202, a rules engine 204, one or more application units 206, one or more relational database management systems (RDBMS) 208, one or more storage modules 210, one or more secure remote management modules 212 and one or more links 214. An application module may be understood as a target application. The secure remote management modules 212 may link 214 to appliances and application management resources, which may include an interface automation system in some example embodiments to receive configuration files, for example. The secure remote management modules 212 may receive configuration files or other management controls to update appliance 200 and components thereof such as application units 206. The secure remote management modules 212 may implement monitoring of the appliance 200 for security purposes.

FIG. 2 illustrates an example interface appliance 200 that may be configured using configuration files to work in concert to support a given target application by integrating a given set of data sources and interfaces. The output of the interface automation system may the configuration files use to implement functions of the interface appliance. However, in some embodiments the interface automation system itself (e.g. as shown in FIG. 1) may be hosted on the appliance 200 to update and modify the configuration files. In other embodiments, the appliance 200 may be connected to the interface automation system to receive the configuration files.

The integration framework unit 202 may be configured to acquire, filter and transform data from one or more near-real, real-time or batch data interfaces from one or more hospital information systems (HIS) 110a, 110b, 110c, and to provide the relevant subsets of information to both the RDBMS 208 and the business rules module 204. In some embodiments, integration framework unit 202 may implement aspects of the interface automation system for dynamically updating a rules engine 204 of interface rules to expand a training rule set using the machine learning operations and the tagged input data. The rules engine 204 may be configured with a rules based on the configuration files. In other embodiments, the rules engine 204 may implement aspects of the interface automation system for generating deployable configuration files for an interface for transforming and integrating input data based on one or more data sources 110a, 110b, 110c and the one or more target applications, the interface being of the interface type. The deployable configuration files configuring the interface on an interface appliance 200 connecting the two or more information systems 110a, 110b, 110c and the one or more target applications. The rules engine 204 may include rules or parameters from the configuration files in some embodiments.

The configuration parameters that control the integration framework may be client-specific to match the source data 110a, 110b, 110c. For example, the interface logic might validate portions of the data; store a copy; acknowledge the sender; filter out unneeded information; apply rules that correlate or map the source data 110a, 110b, 110c to the target application (e.g. patient events with specific sending facilities); apply transformations to prepare the data for subsequent processing; and then route data to one or more destinations, such as the rules engine 204 for further processing and transformation based on the target applications.

The rules engine 204 typically applies a rule set to the data to transform and integrate the data 110a, 110b, 110c to data structure format suitable for the target application, which may enable various features and functionality within the application unit 206 (e.g. the target application). An infection control application (an example of 206) may rely on patient data correlations (as defined in rules engine 204 (and configured using configuration files) that are derived from multiple HIS interfaces 110a, 110b, 110c. For example, administrative, demographics and location information about the patient may be presented along with their laboratory test results to facilitate daily tasks by infection preventionists at hospital.

The output configuration files from the interface automation system may be used to implement the interfaces (of the appliance 200) with one or more HIS data sources 110a, 110b, 110c as managed by the integration framework 202, as well as the rules applied to the data in the rules engine 204. FIG. 2 illustrates this by surrounding both modules in gray and referencing 124—the deployable configuration files—that were first described in FIG. 1. In some embodiments, the integration framework 202 may be part of the interface automation system and used to generate the configuration files. Accordingly, the integration framework 202 may implement appliance 200 to be a standalone unit to connect and transform data from HIS interfaces 110a, 110b, 110c to target applications, and also generate the configuration files that configure the appliance 200 for the connection and transformation. The configuration files may have specific parameters for data protocols, connection protocols, data models, data mappings, data attributes, decision tree structures, and so on to enable communication between the HIS interfaces 110a, 110b, 110c and target applications.

The HIS interfaces (e.g. data sources) 110a, 110b and 110c are examples illustrated to convey the disparate nature of data sources that the interface appliance 200 may need to support. For example, 110a may implement HL7 version 2.3 for admission, discharge, transfer (ADT) data, while 110b may implement HL7 version 3 health quality measure format (HQMF) for quality measures reporting, and 110c may implement electronic data interchange (EDI) for supply chain services. Each of these interfaces would be built to support different health standards. The interfaces may vary from those provided herein as examples.

In a different example, the appliance 200 may connect to or host more than one (target) application unit 206, each of which may require integration with one or more HIS 110a, 110b and 110c. For this example, the application unit 206 is shown as part of the appliance 200 but it may also be separate from the appliance 200 and connected thereto via a network. All data that flows through the appliance 200 may be provided to interface automation system (or they may be integrated as described herein) so that use of the appliance 200 may feed input into the learning operations to refine and improve the learning operations and in turn the generate of configuration files for the appliance 200. Accordingly, the interface generation process may be a continuous and iterative process to dynamically update the appliance 200 configuration by way of the configuration files (and updates thereto).

As an illustrative example of the appliance 200, an incident reporting application (from application unit 206) may only require integration with the hospital's ADT system, while an infection control application (from that same or another application unit 206) may require integration with the ADT system and its LIS and RIS. Focusing on ADT only, the parameters/rules defined in the integration framework unit 202 and the rules engine 204 (as controlled by the configuration files 124) may accommodate different requirements and transformation, which are driven by each target application. The incident reporting application may require 18 ADT rules, while the infection control application may require 50 ADT rules. At the transport level, the hospital may provide a single ADT data feed to the appliance 200, relying on the integration framework unit 202 to split the feed as needed in support of two sets of rules defined by the two application units 206. This is an example only and the appliance 200 may split the incoming data feed into multiple sets, or integrate multiple data feeds into a unified set, implement data transformations, and so on to bridge a connection between the disparate data sources 110a, 110b, 110c and the application unit 206.

As shown, an application unit 206 may serve output data to one or more client devices, and may reside on client devices in some examples. The client devices may provide feedback to application unit 206 for refinement of the learning operations, as described herein.

The relational database management system 208 may store a portion of data flowing through the appliance 200 in storage device 210 in some example embodiments. Different interface profiles may be stored in storage device 210 and managed by relational database management system 208 so that appliance 200 may be dynamically updated depending on the data sources 110a, 110b, 110c. An initial operation may involve detection and determination of the type of data source 110a, 110b, 110c to trigger loading of the appropriate configuration rules and data storage and transformation process.

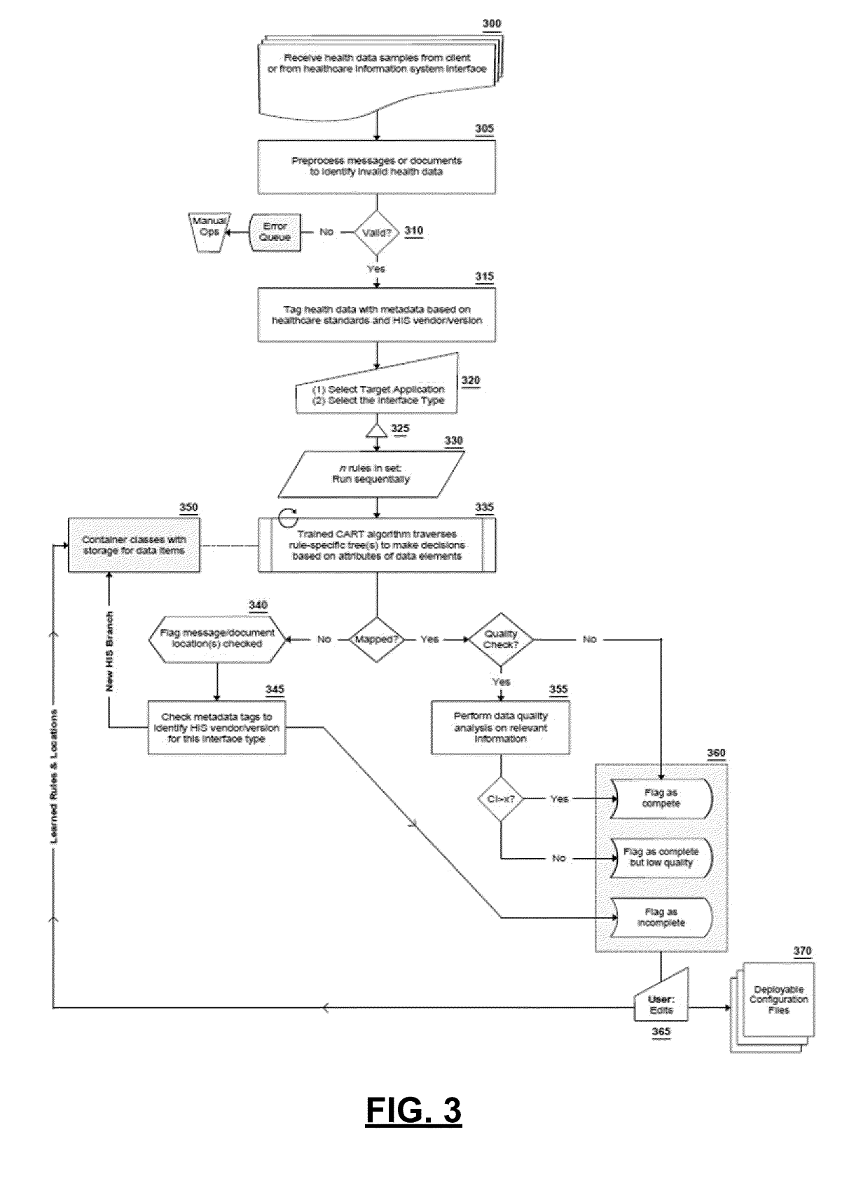

Referring to FIG. 3, a flowchart of a method for interface automation may be provided. This flow chart steps through the data processing described in FIG. 1.

At step 300, input data (e.g. data sources) from the one or more health care information systems may be received and made available to the interface automation system. Input data may be received as a set of samples from a given client for training in an embodiment where the interface automation system may be itself hosted on a physical appliance. The input data may be received as real-time and/or in synchronous or asynchronous batches depending on the particular set up of the source system.

At step 305, the input data may be preprocessed for validation. Data may be found valid or invalid for a variety of reasons. The difference may be that invalid data are not formatted properly for processing, or contain errors. For example, in the context of HL7 v2, the message header may contain the message type (e.g. ADT), the sending facility (e.g. the specific hospital in a health system), the date/time the message was sent, and other critical information. Should this information be missing or unreadable, the message may be identified as invalid. Invalid data may be stored in an error queue and manually reviewed and managed at a later time 310.

At step 315, valid data may be tagged with information or metadata that identifies the relevant standard, its version or reference model, locations of data elements, identification of attributes or known data values, and the source HIS vendor and version. As noted above, the tagging process may help address data variance issues encountered when the learning processes traverse their decision trees. The input data may contain metadata about the data values which may be extracted and processed to generate tags for the data values. The input data may be from unstructured text where learning operations discover meanings of words and terms within the unstructured text. The meanings learned may be used for tagging, in some examples.

An interactive step 320 may involve feedback and refined, where the user selects the target application (e.g. incident reporting, infection control, claims management, and so on) and then one interface type (e.g. ADT) required by the application. This user input instructs the system as to the appropriate learning operations to call, which in turn consumes the client-specific, preprocessed data set for analysis. In some embodiments, step 320 may be fully automated where the target application may be determined based on network connections and data signals received from the target application and the interface type may be determined based on system configurations. Step 325 illustrates that the data set may require filtering (e.g. removal of unnecessary message types or information) as controlled by the rule set for the selected interface.

Step 330 indicates that the system now has a set of n interface rules it will attempt to automatically configure to generate the configuration file. In general, each interface rule may be automatically configured individually, and the sequence may depend on how various rules operate in concert or depend on one another in service of a given interface.

At step 335, the learning algorithm may traverse one or more decision trees for each interface rule in the set. The algorithm may have been trained with the expected locations for data elements that may be tested at each split in the tree structure, as well as the expected results. More specifically, the features for each interface rule may be comprised of a series of decisions, where outcomes are based on the results of each test on some attribute of each data element in the tree. For example, a Message Control ID may be provided in the header of each HL7 message, and while it should always be a unique numerical value, in some cases it may be not. Because the interface may be responsible for overcoming limitations of this nature, the rule may be checking whether or not the full set of ADT messages contains unique Message Control ID values. Message Control ID may be the data element and the attribute being tested at one split in the tree structure may be uniqueness. The result of this decision point may instruct the interface configuration accordingly.

The circular arrow at 335 denotes the iterative nature of the rule set automation process. The result of each rule mapping attempt is: yes (successfully mapped through the tree) or no (failed to map through the tree). At this point, the learning algorithm has completed its attempt to configure a given rule within the set, though further interface configuration efforts and iterations may occur.

If yes (success), the next decision point in the flowchart may be whether the mapped rule requires a quality check. For example, if the patient's Discharge Date has been mapped for a rule that needs it, the system may have already validated the string format of the date field and no further analysis may be needed. If however a drug code has been mapped for a given pharmacy interface rule, because it is coded data, the system may need to check whether or not the code is present in a specific range, which indicates the drug class and therefore its use by the target application. For example, an infection control application tracks some drug classes (e.g. anti-infective, antimicrobial) but not others.

If a quality check is not needed, the system may consider the rule to be mapped and thus written to the database 360 and flagged as complete.

If a quality check is needed, the system may apply the rule-appropriate logic to qualify the information. This may generate a confidence score for the rule, in some examples The confidence score or confidence interval (CI) may be a variable estimate of the accuracy and utility of the rule-specific information. As CART analyses are not based on a probabilistic model, various other types of CI may be employed. As non-limiting example, two example types of CI are described. In a first example, rule-specific, score-based CIs may be used. Here, the CI is not a measurement of how reliably the algorithm mapped a given rule. Rather, the CI may attempt to measure the reliability of the result based on known (expected) information about a given rule. This may be developed during training, for example. In the second example, a CI may be determined based solely on historical accuracy, which may be related to how well the algorithm mapped this or similar rules in the past. In some embodiments, these two CI types may be utilized in various combinations, in part or in whole. A mapped rule with a CI of greater than x; may be written to the database 360 and flagged as complete. A mapped rule with a CI of less than x; may be written to the same and flagged as complete but of low quality. The CI threshold, x, may itself be configurable, allowing the quality logic to be more or less restrictive. The purpose of the confidence interval may be to empower the user 365 with information that may accelerate any manual edits to the interface configurations that remain after automation. There may be specific level of accuracy required for an interface rule in order to be considered for generation of the configuration files and the CI may provide a mechanism to evaluate the accuracy by comparison to one or more threshold values or ranges indicative of an accepted level of confidence.

Back at the outcome of step 335, if a given interface rule is not mapped, the system may be configured to provide a process to automatically resolve the failure in subsequent iterations. As noted previously, a given rule may fail to be mapped due to unexpected variance in the source data. That is, the process may have attempted to test one or more attributes of one or more data elements that it could not locate. At step 340, the one or more message/document locations that were checked by the process are flagged in preparation for next steps.

At step 345, the system may be configured to check the tagged metadata to confirm the HIS vendor/version of the in-process data set, and may then execute two further steps.

First, new HIS-specific information may be created in the container classes at step 350. Container classes may be data structures that provide storage and retrieval capabilities for data items referenced by the algorithm. HIS-specific information may be understood as a new branch in the learning tree. The new branch acts as a placeholder where subsequent user-driven learning may be captured, allowing the system to interactively grow its knowledge of various HIS-specific data element locations for a given interface type. The data not found locations flagged back at step 345 may be provided as part of the information update at step 350, to allow the container classes to appropriately manage the a complete list of possible message/document locations.

Second, the interface rule may be flagged as incomplete in the database at step 360.

Once a given rule set has been processed by the system, the results of the automated analysis may be available to the user. At step 365, the user may view the set of rules that comprise a given interface configuration. As illustrated in step 360, the rule set may be presented to the user as a database view, where each rule has been organized into one of three categories that indicate the status of the automation attempts. The user may then edit the rule configurations in the database, providing corrections and new information as needed, and approving or disapproving the automated rule configurations. Once these changes have been submitted, they are returned to the system at step 350, updating the container classes (data structures) that may be referenced by the learning process in the future. This interactive learning may be potentially useful for improving the efficiency of the learning process over time. For example, the user may resolve issues related to the location of data elements, the quality of data values that were built into interface rules, the relationship between interdependent rules, and various other aspects of the interface configurations. The confirmations and corrections may be feed into the learning process for refinement and improvement.

After user edits 365, the interface configuration files may be ready for deployment at step 370.

The functionality described herein may also be accessed as an Internet service, for example by accessing the functions or features described from any manner of computer device, by the computer device accessing a server computer, a server farm or cloud service configured to implement said functions or features.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. A processor may be implemented using circuitry for configuring an appliance or interface automation system.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including an EGM, a Web enabled TV, a Personal Digital Assistant (PDA), a smart phone, a tablet or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, a computer may receive input information through speech recognition or in other audible formats.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

The system and method may be embodied as a tangible, non-transitory computer readable storage medium (or multiple computer readable storage media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer-readable storage media) encoded with one or more programs that, when executed on one or more computers or other processors, perform methods that implement the various embodiments discussed above. The computer readable medium or media can be transportable, such that the program or programs stored thereon can be loaded onto one or more different computers or other processors to implement various aspects as discussed above. As used herein, the term “non-transitory computer-readable storage medium” encompasses only a computer-readable medium that can be considered to be a manufacture (i.e., article of manufacture) or a machine.

The terms “program” or “software” are used herein in to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods as described herein need not reside on a single computer or processor, but may be distributed in a modular fashion amongst a number of different computers or processors to implement various aspects.

Computer-executable instructions may be in many forms, such as program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Depending on the particular implementation and various associated factors such as the resources of the communications device, wireless network parameters, and other factors, different implementation architectures may be used for the present invention.

It should also be understood that the computer server may be implemented as one or more servers in any possible server architecture or configuration including, for example, in a distributed server architecture, a server farm, or a cloud based computing environment.

Wherever the system is described as receiving input from the user of the communications device, it is to be understood that the input may be received through activation of a physical key on the communications device, through interaction with a touch screen display of the communications device, through a voice command received at the communications device and processed by the system, through a user gesture observed and processed at the communications device, through physically moving the communications device in a predetermined gesture pattern including shaking the communications device, through receiving data from another local or remote communications device associated with the user, or through any other sensory interaction with the communications device or otherwise controlling the communications device.

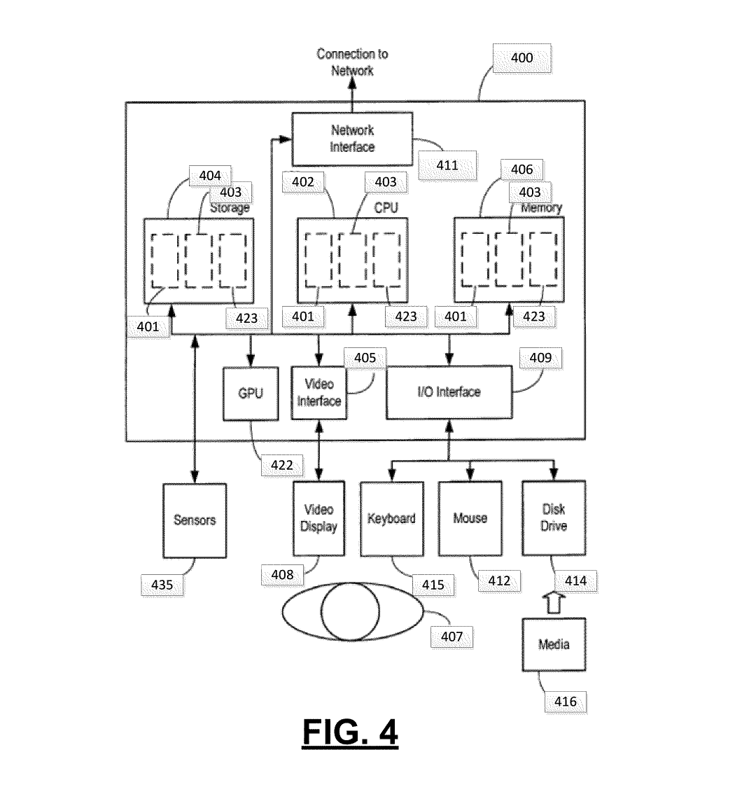

The present system and method may be practiced in various embodiments. A suitably configured computer device, and associated communications networks, devices, software and firmware may provide a platform for enabling one or more embodiments as described above. By way of example, FIG. 4 shows a computer device 400 that may include a central processing unit (“CPU”) 402 connected to a storage unit 404 and to a random access memory 406. The CPU 402 may process an operating system 401, application program 403, and data 423. The operating system 404, application program 403, and data 423 may be stored in storage unit 404 and loaded into memory 406, as may be required. Computer device 200 may further include a graphics processing unit (GPU) 422 which is operatively connected to CPU 402 and to memory 406 to offload intensive image processing calculations from CPU 402 and run these calculations in parallel with CPU 402. An operator 407 may interact with the computer device 400 using a video display 408 connected by a video interface 405, and various input/output devices such as a keyboard 415, mouse 412, and disk drive or solid state drive 414 connected by an I/O interface 409. The mouse 412 may be configured to control movement of a cursor in the video display 408, and to operate various graphical user interface (GUI) controls appearing in the video display 408 with a mouse button. The disk drive or solid state drive 414 may be configured to accept computer readable media 416. The computer device 400 may form part of a network via a network interface 411, allowing the computer device 400 to communicate with other suitably configured data processing systems (not shown). One or more different types of sensors 435 may be used to receive input from various sources. The application program 403 may be a target application in some example embodiments, or may be a client application program 403 that connects to a target application. As another example, the application program 403 may be a client interface program configured to control display 408 to provide a visual representation of the configuration file and receive feedback or confirmation (via I/O interface 409) regarding the configuration file for provision to learning process.

The present system and method may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

The embodiments described herein involve computing devices, servers, receivers, transmitters, processors, memory, display, networks particularly configured to implement various acts. The embodiments described herein are directed to electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, a various hardware components.

Substituting the computing devices, servers, receivers, transmitters, processors, memory, display, networks particularly configured to implement various acts for non-physical hardware, using mental steps for example, may substantially affect the way the embodiments work.

Such computer hardware limitations are clearly essential elements of the embodiments described herein, and they cannot be omitted or substituted for mental means without having a material effect on the operation and structure of the embodiments described herein. The computer hardware is essential to the embodiments described herein and is not merely used to perform steps expeditiously and in an efficient manner.

While illustrated in the block diagrams as groups of discrete components communicating with each other via distinct electrical data signal connections, the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching example embodiments.

It will be appreciated by those skilled in the art that other variations of the embodiments described herein may also be practiced without departing from the scope of the invention. Other modifications are therefore possible.

In further aspects, the disclosure provides systems, devices, methods, and computer programming products, including non-transient machine-readable instruction sets, for use in implementing such methods and enabling the functionality described previously.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances, without departing from the scope of the invention, which is to be limited only by the claims.

### EXAMPLE APPLICATIONS

The following is a non-limiting example of some embodiments provided for illustrative purposes.

In support of an incident reporting solution at hospital, a set of interface rules that comprise an admission, discharge, transfer (ADT) interface are being automated by the system to generate configuration files for an interface appliance.

The interface appliance may provide patient administration data to the incident reporting application, which may be hosted on a physical appliance residing in the hospital datacenter. An integration framework and business rules module may also reside on the appliance, and be configured to interoperate to acquire real-time HL7 v2 messages from the hospital's ADT system for integration with the incident reporting application. When operating the incident reporting application, end users (front-line staff) at hospital, may rely on ADT integration to perform patient lookups when creating and submitting incident reports on adverse events that occur at hospital.

In the example, two weeks of sample ADT data have been provided by the hospital for the purpose of analysis as part of the implementation of the incident reporting solution. This data set may be consumed by the interface automation system, validated and tagged.

The system user may select incident reporting as the target application and ADT as the interface type. The learning algorithm for this target application and this interface type may have been trained to know the set of interface configurations required. This example highlights one rule from the set.

Within the ADT transaction set, there may be the concept of a patient identification hierarchy. The standard may provide various methods for identifying a person within a multi-site health system, a patient within a specific facility (site), any episodes of care the patient underwent at the facility, and potentially multiple visits within each episode of care.

The incident reporting application needs to correlate ADT messages that reflect each patient's episode of care and/or visit, depending on how the hospital chose to implement this logic in their environment. More specifically, the rule may analyze an ADT data set to determine the appropriate patient account/visit identifier, the patient class (e.g. emergency, inpatient, outpatient, pre-admit and so forth), and the type of outpatient, in order to map a unique Patient Stream. Mapping the Patient Stream may help improve tracking, organization and display of patient information in the incident reporting application. This may involve updates to patient demographics, and various location- and care-related events within and across episodes of care. Mapping of this rule may also facilitate the correlation of information from other hospital services, such as the patient's laboratory results and the administration of drug therapies.

This example illustrates how an interface rule may be automatically mapped by a learning algorithm that employs a decision tree, where the series of tests on features of the data have been defined through previous training, validation and testing stages, as part of supervised learning.

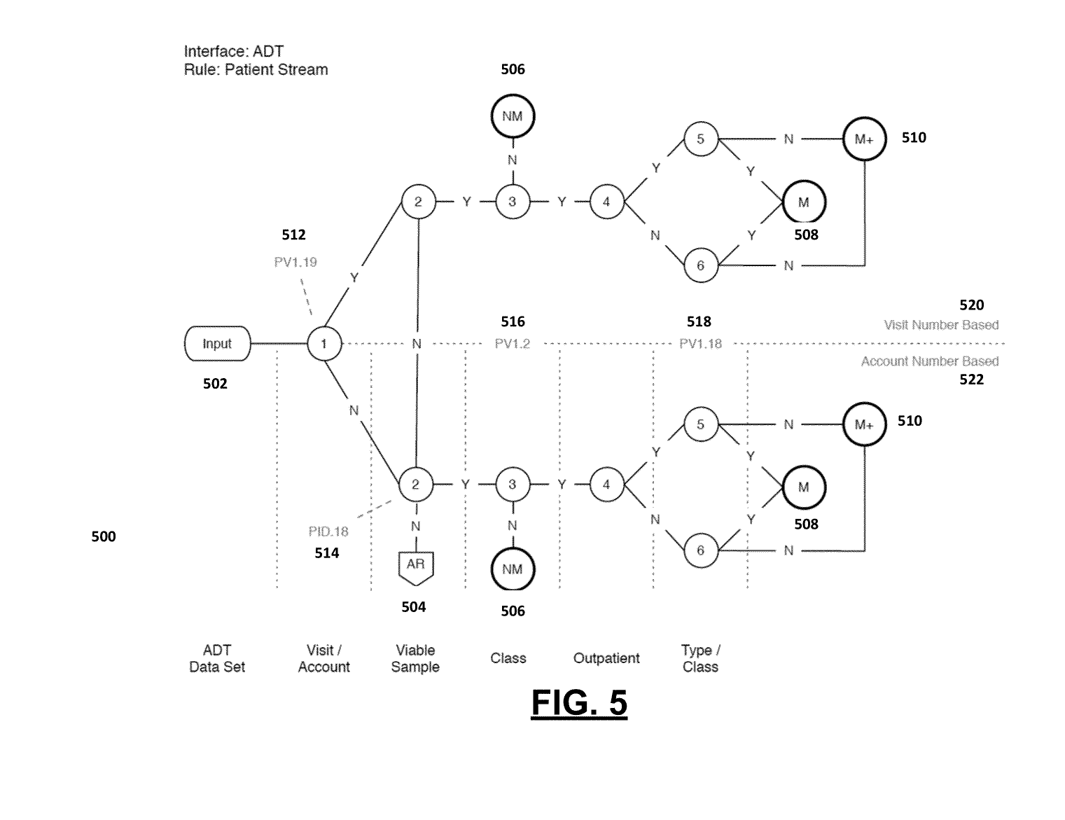

FIG. 5 shows a decision tree data structure 500 that may be stored persistently as a data structure on a data storage device that may be made available to user devices, applications, interface automation system rules engines, and so on as non-transitory signals. The decision tree 500 may include a subset of nodes 520 that are visit number based and a subset of nodes 522 that are account number based to represent different patient streams. The decision tree 500 starts with n ADT messages (the data set) as input 502. Each numbered circle may depict an internal node in the tree 500, which represents a test on some attribute of the input. The circle's number indicates the sequence of tests (decisions) that may be traversed. Each Y (yes) or N (no) branch represents the outcome of the test. The wide arrow and bolded circles may represent end nodes in a branch and may use the following notation. The example end nodes may include AR node 504, NM node 506, M node 508, M+ node 510.

TABLE 1
End Node Designators

| End Node | Full Name | Description |
|---|---|---|
| AR | Alternate Rule | This end node may indicate an alternate rule is needed. An |
| | | alternate rule may be called in cases where required information |
| | | from the input (data set) is not found in the expected location(s). |
| | | The alternate rule would attempt to resolve the issue by locating |
| | | the information, and, if successful, the original rule may be updated |
| | | to check the new location(s) in its second attempt. |
| M | Mapped | This end node may indicate the rule has been successfully |
| | | mapped, and no quality check is required. |
| M+ | Mapped + | This end node may indicate the rule has been mapped as far as |
| | Quality Check | possible; however there are aspects of the output that may benefit |
| | | from a quality check, as the next step in the process. There may be |
| | | various types of quality check that support a given rule set. One |
| | | type of quality check may provide more complete information than |
| | | is available to the decision tree through its input. Another type may |
| | | attempt to ensure that a value read from the input is in the correct |
| | | format (e.g. a rule-relevant date/time field from a set of ADT |
| | | messages may be correctly parsed to understand the year, month, |
| | | day, hour, minute and second). Further detail on the first example |
| | | is provided below. |
| NM | Not Mapped | This end node may indicate the rule could not be mapped. This |
| | | may occur in cases where required information has been located |
| | | within the data set (input), however the value or values are |
| | | unexpected. This may also occur when required information from |
| | | the input could not be located, and the system cannot |
| | | programmatically resolve the issue. In either case, this end node |
| | | may require resolution by the user. |

The above notation may indicate the result of the mapped decision after step 335 in the FIG. 3 flow chart.

FIG. 5 also notes the following HL7 field location indicators PV1.19 512, PID.18 514, PV1.2 516, PV1.18 518.

TABLE 2
HL7 Field Locations

| HL7 Field | |
|---|---|
| Location | Description |
| PV1.19 | Standard location for the patient's visit number. |
| PID.18 | Standard location for the patient's account number |
| PV1.2 | Standard location for the patient class - this may be an |
| | HL7-defined set of designators that indicate all possible types |
| | of patient services provided at hospital. |
| PV1.18 | Standard location for the patient type - this may be a set of |
| | hospital-defined designators that indicate the types of |
| | outpatient services provided at hospital. |

Each HL7 field location identifies the segment and field number in the ADT message that may be read by the decision tree as it tests a given attribute of the input. Moving from left to right, the path through the tree may be determined by the binary (yes/no) result of each test.

Node with circle numbered 1 is the first decision in the tree 500 and may be referred to as decision 1. Decision 1 may be a test (e.g. rule) as to whether the input 502 contains values for the patient visit number in PV1.19. This may be the initial split between a visit number 520 and an account number 522 based Patient Stream.

With one exception, after decision 1, the tree 500 may be traversed on either the upper (visit) subset of nodes 520 or the lower (account) subset of nodes 522, moving from left to right.

TABLE 3
Decisions for Visit Based Patient Stream
Visit Based (upper)

| Symbol | Meaning | Description |
|---|---|---|
| \textcircled{2} | Decision 2 | Does the input contain a representative sample |
| | | of visit numbers in PV1.19? |
| \textcircled{3} | Decision 3 | Does the input contain patient class values in |
| | | PV1.2? |
| \textcircled{4} | Decision 4 | Does the patient class value equal ‘O’? |
| \textcircled{5} | Decision 5 | Does the input contain a patient type value in |
| | | PV1.18? |
| \textcircled{6} | Decision 6 | For messages where patient class is not equal to ‘O’, |
| | | does the patient class value match one among the |
| | | list of expected designators? |

If decision 1 results in yes, decision 2 may test whether the visit number is a representative sample of the input. For example, if >=95% of messages in the data set contain a visit number, then the input provides a high enough percentage for the system to determine that the hospital may indeed be using visit numbers to track and identify patients within and across their hospital information systems.

Decision 3 may test the availability of the patient class in PV1.2. Standard patient class values may be described as follows:
E Emergency
I Inpatient
O Outpatient
P Pre-admit
R Recurring patient
B Obstetrics

If patient class is not available, the logic branches to an end node of type NM 506 and exits. As noted in Table-1, not mapped may indicate that required information is not available from the input. In this example, because the visit number was already tested from its expected location and the data set was found to contain a viable sample of visit numbers, the subsequent result that patient class was not found is significant enough to warrant not mapped, indicating that user analysis of the data is needed.

Due to the nature of outpatient services, each hospital may define their own list of outpatient types. The rule therefore may attempt to identify these types for inclusion within the Patient Stream.

If patient class is available, decision 4 tests whether the patient is of class O (outpatient).

If yes, decision 5 tests availability of the patient type in PV1.18. If patient type—a hospital-defined list of outpatient types—is available, the branch terminates at an end node of type M 508. This would result in a unique Patient Stream for outpatients comprised of the following elements:
<visit number>+<patient class>+<patient type>

If patient type is not available, the branch terminates at an end node of type M+510. As noted in Table-1, mapped+quality check may indicate the rule has been mapped as far as possible; however there are aspects of the output that may benefit from a quality check. In this example, the rule has been mapped except for outpatients, and the subsequent quality check may provide information that is not available from the input, such as a hospital-specific, pre-defined list of outpatient type designators, or even a default designator. Thus in this case, a unique Patient Stream for outpatients may include the following elements:
<visit number>+<patient class>+<pending quality check>

If the patient is not an outpatient, decision 6 tests whether the patient class is one of the remaining list of expected values (e.g. E, I, P, R or B). If yes, the branch terminates at an end node of type M 508. This would result in a unique Patient Stream for all patient classes except outpatients, comprised of the following elements:
<visit number>+<patient class>

If there are unknown patient class values, the branch terminates at an end node of type M+, which indicates mapped+quality check. In this case, the quality check may define additional patient class designators that allow the unknown types to be used as part of the Patient Stream, or it may indicate specific patient class designators are not relevant to the ADT interface.

TABLE 4
Decisions for Account Based Patient Stream
Account Based (lower)

| Symbol | Meaning | Description |
|---|---|---|
| \textcircled{2} | Decision 2 | Does the input contain a representative sample of |
| | | account numbers in PID.18? |
| \textcircled{3} | Decision 3 | Does the input contain patient class values in |
| | | PV1.2? |
| \textcircled{4} | Decision 4 | Does the patient class value equal ‘O’? |
| \textcircled{5} | Decision 5 | Does the input contain a patient type value |
| | | in PV1.18? |
| \textcircled{6} | Decision 6 | For messages where patient class is not equal to ‘O’, |
| | | does the patient class value match one among the |
| | | list of expected designators? |

If decision 1 branches to no, or if [upper] decision 2 branches to no, [lower] decision 2 tests PID.18 514 across the data set for a representative sample of account numbers.

If there is not a viable sample of account numbers, the branch terminates at an end node of type AR. Because key patient identifiers have not been located, as noted in Table-1, this end node may call an alternate rule, which may attempt to locate these identifiers, update the Patient Stream rule field locations, and then re-run the Patient Stream rule.

If decision 2 branches to yes, the remainder of the account based (lower) side of the decision tree, (i.e. starting at decision 3 and moving forward), may be identical to the visit based (upper) side, with the following caveats:

The Patient Stream for outpatients would be comprised of:
<account number>+<patient class>+<patient type>

The Patient Stream for all other patient classes would be comprised of:
<account number>+<patient class>

All other tree branching logic and behavior per end nodes may be the same.

FIG. 6 is a schematic diagram of a system for health care data integration using an interface appliance 604 and configuration files 606 according to some embodiments.

As described, embodiments described herein may provide health care data integration solutions that automatically generate an interface appliance 604 between a client site and a back-end data processing server using machine learning techniques such as meta-data discovery and key words/term discovery from free form unstructured text data.

The interface appliance 604 may serve multiple clients and different types of data sources 602a . . . 602n. The interface appliance 604 may be generated and modified using configuration files 606, which may be output by the interface automation and machine learning processes described herein. In some example embodiments, the interface appliance 604 may include machine learning components to generate and update its own configuration files 606. The interface appliance 604 may be installed at a client site to integrate and map client data (e.g. data sources 602a . . . 602n) to back-end server data formats (e.g. site server 608, central server 618). The interface appliance 604 receives as input from different data sources 602a . . . 602n. Client data from the data sources 602a . . . 602n may be specific to a given health care facility or organization and flexible standards (e.g. HL7) result in significant data variance within the same health care organization and between different clients or organizations. Each client may require a specific custom interface appliance 604 in some example embodiments as the formatting and content of the data sources 602a . . . 602n vary from one client to another. For example, a patient data record may have ten data fields for one client and may have twenty data fields for another client. The data fields may have different names for the same type of data value between clients, the formatting of the data values may vary, and so on. The difference in the format and content of the data sources 602a . . . 602n typically make interface generation a manual and time intensive process and embodiments described herein may automate interface generation and implementation using machine learning techniques to generate configuration files 606 for the interface appliances 604. The configuration files 606 may include mappings and libraries to translate and transform source data to target data. Over time, training and developing a critical mass of mappings and libraries may improve accuracy and efficiency of the machine learning techniques. The machine learning techniques may be based on rules, instructions, mappings, taxonomies, user feedback, etc. The mappings and libraries may be automatically generated by processing source data for pattern detection, and so on. The configuration files 606 may be used to automatically construct the interface appliance 604 to implement the interface between the client data sources 602a . . . 602n and the back-end server (e.g. site server 608, central server 618).

The data sources 602a . . . 602n may be based on two or more standards, formats, interfaces, and so on, and the interface appliances 604 may combine the data sources 602a . . . 602n using the mappings and libraries to transform the data into a suitable format for the back-end server (e.g. site server 608, central server 618). The learning process used to generate the configuration files 606 may be refined over time by processing more data sources 602a . . . 602n, user feedback, error detection and correction, and processing of known data formats and sources in increase accuracy and efficiency of the pattern matching process to detect patterns within the data sources 602a . . . 602n.

Each data sources 602a . . . 602n may contain various inputs and outputs that map to one another, but it is not always consistent or clear how the data maps, and how data was input by various users of a healthcare system. For example, there may be different variable or data field names, metadata, formatting, and so on. Healthcare professionals often input inconsistent and/or incomplete information and these issues have impacts on the quality of data and interoperability and compatibility of devices and systems. Manual mapping can be extremely cumbersome and an automated mapping system utilizing learning processes may be provided by embodiments described herein. Through a learning process, such as a supervised learning process, the interface appliance 604 is adapted to maintain and update rules that are used to map how data sources 602a . . . 602n interact with one another. For example, the user interfaces that receive input data (to populate data sources 602a . . . 602n) may be used on separate machines or systems, each using an open or flexible format such as HL7, but in different contexts or usages.

Each of the mappings of the interface appliance 604 and configuration files 606 may be associated with a confidence score based on the perceived confidence that various mappings are correct or accurate. In some example embodiments, the mapping process is conducted through traversal of a tree of decision points, where each branch of the tree may be associated with a particular weight. This weight may be refined over time as decisions are validated (e.g., through a supervisor's review). This weight may be used to generate or compute the confidence score for the mapping. The confidence score can be used to flag mappings that will need review before usage (e.g., greater than a first threshold but lower than a second threshold). That is, the confidence score may be compare to one or more threshold values to trigger a flag for review or confirmation. The confidence score may also be context dependent and based on the type of data it maps. For example, if the mapping of the confidence score relates to a critical decision with no room for error, the threshold may increase or decrease. The mapping and confidence score may vary based on the feedback or confirmation received, which may improve or refine the learning process over time.

The interface appliance 604 may connect to a site server 608 which may be local to the interface appliance 604 or may be remote but part of the same health care organization. The site server 608 may connect to different target applications 610, user interface applications 612, and post-processing devices 614 which may all receive data processed by interface appliance 604. A data storage device 628 may serve site server 608 and store data received from interface appliance 604. The target applications 610 may be specific to the health care organization. The user interface applications 612 may display a visual representation of the configuration files 606 to receive feedback for refinement of the learning process. The interface appliance 604 may transform input data from data sources 602a . . . 602n and transmit to site server 608 to make the output data available to target applications 610, user interface applications 612, and post-processing devices 614.

The interface appliance 604 may connect to a network 616 and a central server 618 that may serve multiple health care organizations. The central server 618 may connect to different target applications 620, user interface applications 622, and post-processing devices 624 which may all receive data processed by interface appliance 604. A data storage device 626 may serve central server 626 to integrate and store data received from interface appliance 604 and other interface appliances 644. The target applications 620 may be used for one or more health care organizations. The user interface applications 622 may display a visual representation of the configuration files 606 to receive feedback for refinement of the learning process for provision to interface automation system or interface appliance 604. The interface appliance 604 may transform input data from data sources 602a . . . 602n and transmit to central server 618 to make the output data available to target applications 620, user interface applications 622, and post-processing devices 624.

Accordingly, interface appliance 604 may connect to a site server 608, a central server 618 or both to provide output data to target applications 610, 620.

As shown, additional interface appliances 644 may connect to network 616 and the central server 618. The other interface appliance 644 may provide output data for the same or different target applications 620 than the interface appliance 604. The other interface appliance 644 may connect to different data sources 642a . . . 642n to receive input data for provision to the central server 618. This is an example and there may be additional interface appliances. The interface automation system is a scalable system that can serve many different target applications and data sources, using different network topologies and system architectures, including layers and hierarchies of servers and storage as needed for a system.

These are examples for illustrative purposes and other embodiments may be use different implementations for the interface automation system and interface appliance.

What is claimed is:

1. An interface automation system comprising:
(a) a training unit for processing labeled training data using machine learning operations for rule generation to generate a training rule set for mapping feature data to one or more target variables;
(b) a data interface for receiving input data from data sources of two or more information systems, an interface type, and a selected one or more target applications;
(c) a preprocessor for validating and tagging the input data, the tagging identifying data element locations within the input data;
(d) an integration framework unit for dynamically updating interface rules to expand the training rule set using the machine learning operations and the tagged input data, the integration framework unit generating deployable configuration files for an interface for transforming and integrating input data based on the one or more data sources and the one or more target applications, the interface being of the interface type, the deployable configuration files configuring the interface on an interface appliance connecting the two or more information systems and the one or more target applications.

2. The interface automation system of claim 1, wherein the labeled training data comprises class-labeled training tuples of types x and Y, where x is a vector of input variables (x1, x2, x3, . . . , xn) and Y is the one or more target variables that the training unit is attempts to understand using the machine learning operations for the rule generation.

3. The interface automation system of claim 1, wherein the configuration files comprise parameters or rules to control the transformation and integration of the input data, each parameter or rule associated with a confidence score, the confidence score being a variable value to estimate the accuracy and utility of the parameter or rule, the confidence score being within a predetermined threshold.

4. The interface automation system of claim 1, further comprising a client application for providing a visual representation of the configuration files, receiving feedback regarding accuracy of the configuration files, refining the machine learning operations based on the received feedback, and updating the configuration files using the refined machine learning operations.

5. The interface automation system of claim 1, wherein a rules engine manages the interface rules based on the expanded training rule set, each interface rule for configuring one or more parameter of the configuration files for the transforming or integrating of the input data to one or more target variables, each interface rule defined by a path traversing a series of decisions nodes in a tree data structure to map observations from the input data to conclusions about the input data, wherein the path configures the one or more parameters of the configuration files.

6. The interface automation system of claim 1, further comprising the interface appliance connected to the integration framework unit to dynamically receive new and updated configuration files.

7. The interface automation system of claim, wherein the input data comprises a set of features defined by one or more attributes of one or more data elements, wherein the rules engine of the interface rules uses the machine learning operations to discover, identify and classify the set of features of the input data to update or refine the interface rules.

8. An interface appliance comprising:
(a) at least one input port connecting to two or more information systems to receive input data from data sources of the two or more information systems;
(b) a data interface for receiving an interface type, and at least one selected target application;
(c) at least one output port connecting to at least one target application for providing output data generating by transforming and integrating the input data;
(d) at least one deployable configuration file for generating an interface on the interface appliance connecting the two or more information systems and the at least one selected target application, the interface being of the interface type;
(e) a preprocessor for validating and tagging the input data, the tagging identifying data element locations within the input data; and
(f) an integration framework unit for dynamically updating interface rules using the machine learning operations and the tagged input data, the integration framework unit generating the deployable configuration files for the transforming and integrating of the input data based on the one or more data sources and the one or more target applications.

9. The interface appliance of claim 8, wherein the configuration files comprise parameters or rules to control the transformation and integration of the input data, each parameter or rule associated with a confidence score, the confidence score being a variable value to estimate the accuracy and utility of the parameter or rule, the confidence score being within a predetermined threshold.

10. The interface appliance of claim 8, further comprising a client application for providing a visual representation of the configuration files, receiving feedback regarding accuracy of the configuration files, refining the machine learning operations based on the received feedback, and updating the configuration files using the refined machine learning operations.

11. The interface appliance of claim 8, wherein integration framework unit connects with a rules engine to manage the interface rules, each interface rule for configuring one or more parameter of the configuration files for the transforming or integrating of the input data to one or more target variables, each interface rule defined by a path traversing a series of decisions nodes in a tree data structure to map observations from the input data to conclusions about the input data, wherein the path configures the one or more parameters of the configuration files.

12. The interface appliance of claim 8, wherein the integration framework unit dynamically updates the configuration files on the interface appliance based on refinement of the machine learning operations.

13. The interface appliance of claim 8, wherein the input data comprises a set of features defined by one or more attributes of one or more data elements, wherein the rules engine of the interface rules uses the machine learning operations to discover, identify and classify the set of features of the input data to update or refine the interface rules.

14. The interface appliance of claim 8, wherein the input data comprises unstructured textual data.

15. The interface appliance of claim 8, wherein the input data comprises metadata about data values, and wherein the tagging identifies the metadata as tags.

16. The interface appliance of claim 8, wherein the input data comprise one or more near-real time or real time data feeds regarding machines, devices and patients of the one or more health care organizations and other data relevant to the one or more health care organizations for incident prediction.

17. The interface appliance of claim 8, wherein the input data comprise batch data feeds regarding machines, devices and patients of the one or more health care organizations and other data relevant to the one or more health care organizations for incident prediction.

18. The interface appliance of claim 8, integration framework unit determines a confidence interval for the configuration files and compares the confidence interval to a threshold to trigger a flag.

19. A method for interface automation comprising:
receive input data from a plurality of client or healthcare information system interfaces;
reprocess the source data to identify and filter invalid data;
tag attributes and data elements of the input data with tags;
receive a selected target application and interface type;
process the input data using the tags, a rule-specific tree data structures, and machine learning operations to generate configuration files; and
transmit the configuration files to an interface appliance connecting to the plurality of client or healthcare information system interfaces and the target application.

20. The method of claim 19 further comprising
providing a visual representation of the configuration files;
receiving data quality confirmation about the configuration files based on the visual representation;
updating the learning operations based on the data quality confirmation; and
generating deployable configuration files.
